(19) United States
(12) Patent Application Publication
(10) Pub. No.: US 2025/0062411 A1
(43) Pub. Date: Feb. 20, 2025

(54) ELECTROLYTE ADDITIVE FOR LITHIUM ION BATTERIES AND METHOD OF MANUFACTURE THEREOF

(71) Applicant: GM Global Technology Operations LLC, Detroit, MI (US)

(72) Inventors: Gongshin Qi, Troy, MI (US); Chuanlong Wang, Troy, MI (US); Vamakshi Yadav, Sterling Heights, MI (US); Wei Li, Troy, MI (US)

(21) Appl. No.: 18/452,082

(22) Filed: Aug. 18, 2023

(51) Int. Cl. H01M 10/0567; H01M 4/505; H01M 4/525; H01M 10/0525; H01M 10/0568; H01M 10/0569

(52) U.S. Cl. CPC H01M 10/0567; H01M 4/505; H01M 4/525; H01M 10/0525; H01M 10/0568; H01M 10/0569; H01M 2004/028; H01M 2300/0037; H01M 2300/0051

(57) ABSTRACT

In an embodiment, an electrolyte for a lithium-ion battery includes a lithium salt, a phosphorus-containing additive, and a solvent. In an embodiment, a lithium-ion battery comprises an anode, a cathode, an electrolyte and a separator. The anode comprises an anode active layer. The cathode comprises a cathode active layer, where the cathode active layer comprises lithium and manganese-rich layered-structure material. The electrolyte comprises a phosphorus-containing additive. The separator is disposed between the anode and the cathode.

### INTRODUCTION

This disclosure relates to an electrolyte additive for high voltage lithium batteries and a method of manufacture thereof.

Lithium ion batteries have traditionally been used in a variety of small-sized commercial applications such as tablet and laptop computers, cell phones, and the like. More recently, cathode active materials comprising lithium-manganese rich layered oxides (also known as lithium-magnesium-rich (LMR) layered cathode materials) are being utilized because of their high energy density. Lithium-manganese-rich layered oxide materials contain Li₂MnO₃ and LiR₁O₂ layered phase parent structures, where R₁ is nickel. Lithium ion batteries having lithium-manganese-rich layered cathode materials display high reversible charge capacities of greater than 200 milliampere-hours per gram mass (mAh/g). This makes them useful in a variety of high power applications such as in automobiles.

Despite their high specific capacities, these lithium-manganese-rich layered cathode materials are susceptible to a rapid decrease in capacity due to the evolution of the Li₂MnO₃ and LiR₁O₂ layered phase parent structures towards a spinel phase during electrochemical cycling. This effect also results in a lower operating voltage, thereby damaging the energy density of the cell (often referred to as “voltage fade”). During the first charge cycle, this phase change is known to occur at the surface of the electrode particles in combination with oxygen evolution as Li₂O is lost from the Li₂MnO₃ parent structure. During subsequent cycles, the layered to spinel phase change continues from particle shell to core, accompanied by the dissolution of Mn (Mn²⁺). While the phase change occurring during the first cycle may be seen as an “activation” step, the long-term phase change of the lithium-manganese-rich layered oxide material causes a gradual lowering in operating voltage of the cell and capacity degradation, rendering the material inadequate for utilization in lithium-ion batteries.

More specifically, these batteries suffer from several drawbacks when subjected to high voltage operations of greater than 4.3 volts (V). At voltages of greater than 4.3V, electrolyte decomposition occurs resulting in undesirable oxygen release.

Accordingly, it is desirable to provide high voltage performance in lithium ion batteries.

### SUMMARY

In an embodiment, an electrolyte for a lithium-ion battery comprises a lithium salt; a phosphorus-containing additive; and a solvent.

In another embodiment, the lithium salt is present in an amount of 5 to 30 wt %, based on a total weight of the electrolyte.

In yet another embodiment, the lithium salt is lithium hexafluorophosphate, lithium perchlorate, lithium hexafluoroarsenate, lithium tetrafluoroborate, lithium bis(trifluoro-methanesulfonyl)imide, lithium bis(fluorosulfonyl)imide, lithium bis(oxalato)borate, lithium (difluoromethanesulfonyl) (trifluoromethanesulfonyl)imide, lithium difluorooxalatoborate, lithium difluorophosphate, lithium iodide, lithium bromide, lithium chloride, lithium thiocyanate, lithium nitrate, lithium nitrite, lithium sulfate, or a combination thereof.

In yet another embodiment, the lithium salt is lithium hexafluorophosphate (LiPF₆).

In yet another embodiment, the phosphorus-containing additive is present in the electrolyte in an amount of 0.001 to 20 wt %, based on a total weight of the electrolyte.

In yet another embodiment, the phosphorus-containing additive is present in the electrolyte in an amount of 0.1 to 5 wt %, based on a total weight of the electrolyte.

In yet another embodiment, the phosphorus-containing additive is an organophosphite, an organophosphate, an organophosphonite, an organophosphonate, or a combination thereof.

In yet another embodiment, the organophosphite and organophosphinite is a trimethyl phosphite, a triethyl phosphite, a triisopropyl phosphite, a ethyl diphenylphosphinite, a triphenyl phosphite, a tris(2,2,2-trifluoroethyl) phosphite, a tris(1,1,1,3,3,3-hexafluoropropan-2-yl) phosphite, a tris(trimethylsilyl) phosphite, or a combination thereof.

In yet another embodiment, the organophosphate is a trimethyl phosphate, a triphenyl phosphate, a tributyl phosphate, a triethyl phosphate, a tris (2,2,2,-trifluoroethyl) phosphate, a bis(2,2,2-trifluoroethyl) methyl phosphate, tris(1,1,1,3,3,3-hexafluoropropan-2-yl) phosphate, or a combination thereof.

In yet another embodiment, the organophosphonate is a dimethyl methylphosphonate, a diethyl ethylphosphonate, a diethyl phenylphosphonate, a bis(2,2,2-trifluoroethyl)methylphosphonate, a bis(2,2,2,-trifluoroethyl)methyl phosphonate, or a combination thereof.

In yet another embodiment, the phosphorus-containing additive is a tris(2,2,2-trifluoroethyl) phosphite.

In yet another embodiment, the solvent is diethyl carbonate, fluoroethylene carbonate, difluoroethylene carbonate, 1,2-dimethoxyethane, trifluoroethylene carbonate, vinyl ethylene carbonate, 4-methylene ethylene carbonate, ethylene carbonate, propylene carbonate, vinylene carbonate, 4,5-dimethylene-1,3-dioxolan-2-one, dimethyl carbonate, ethyl methyl carbonate, methyl 2,2,2-trifluoroethyl carbonate, dimethyl sulfone, ethyl methyl sulfone, ethyl vinyl sulfone, tetramethylene sulfone, trifluoromethyl ethyl sulfone, trifluoromethyl isopropyl sulfone, trifluoropropyl methyl sulfone, ethylene sulfite, ethylene sulfate, dimethyl sulfoxide, acetonitrile, N,N-dimethylformamide, water, or a combination thereof.

In yet another embodiment, the solvent comprises diethyl carbonate and fluoroethylene carbonate.

In yet another embodiment, the diethyl carbonate is used in an amount of 75 to 85 vol %, based on a total weight of the solvent used in the electrolyte, and where the fluoroethylene carbonate is used in an amount of 15 to 25 vol %, based on a total volume of the solvent used in the electrolyte.

In an embodiment, a lithium-ion battery comprises an anode, a cathode, an electrolyte and a separator. The anode comprises an anode active layer. The cathode comprises a cathode active layer, where the cathode active layer comprises lithium and manganese-rich layered-structure material. The electrolyte comprises a phosphorus-containing additive. The separator is disposed between the anode and the cathode.

In another embodiment, the electrolyte further comprises a lithium salt; where the lithium salt is lithium hexafluorophosphate, lithium perchlorate, lithium hexafluoroarsenate, lithium tetrafluoroborate, lithium bis(trifluoro-methanesulfonyl)imide, lithium bis(fluorosulfonyl)imide, lithium bis(oxalato)borate, lithium (difluoromethanesulfonyl) (trifluoromethanesulfonyl)imide, lithium difluorooxalatoborate, lithium difluorophosphate, lithium iodide, lithium bromide, lithium chloride, lithium thiocyanate, lithium nitrate, lithium nitrite, lithium sulfate, or a combination thereof.

In yet another embodiment, the lithium and manganese-rich layered-structure material has the formula of Equation (1) or Equation (2):

$$( p ) {Li}_{2} {MnO}_{3} ( 1 - p ) {Li R}_{1} {O}_{2} , \qquad ( 1 )$$

where R₁ is Mn, Ni or Co and p is greater than zero and less than 1;

$${Li R}_{x} {M}_{y} {O}_{2} , \qquad ( 2 )$$

where R is Ni and M is at least one of Mn, Ni, Co, or Al, where x+y=1 and where x is greater than 0.30 and less than 0.91.

In yet another embodiment, the lithium and manganese-rich layered-structure material is Li_{z}NiₓMn_{y}Co_{(1-x-y)}O₂, LiNiₓMn_{y}Al_{(1-x-y)}O₂, LiNiₓMn₍₁₋ₓ₎O₂, or a combination thereof, or a combination thereof, where y is equal to or greater than about 0.5 and where x is less than 0.4 and where z is equal to or greater than 1.0 and is less than 1.5

In yet another embodiment, the phosphorus-containing additive reduces a rate of conversion of a layered phase in the lithium and manganese-rich layered-structure material to a spinel phase.

In yet another embodiment, the phosphorus-containing additive is a tris(2,2,2-trifluoroethyl) phosphite.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a schematic depiction of an exemplary lithium ion battery;

FIG. 2 is a schematic depiction of a reaction between the phosphorus-containing additive and oxygen, which results in a removal of oxygen gas generated in the battery;

FIG. 3 is a graph that depicts areal capacity (mAh/cm²) versus the number of cycles for the experimental battery and for the comparative battery; and

FIG. 4 is a graph that depicts normalized capacity retention versus the number of cycles for the experimental battery and for the comparative battery.

### DETAILED DESCRIPTION

The following description is merely exemplary in nature and is not intended to limit the present disclosure, its application or uses.

In accordance with an exemplary embodiment, disclosed herein is a lithium ion battery that contains an electrolyte that comprises a phosphorus-containing additive. The lithium-ion battery also comprises a cathode that has a cathode active material layer that comprises a lithium and manganese-rich (LMR) layered-structure material. The use of an electrolyte that comprises a phosphorus-containing additive reduces the phase change in the cathode active layer from the layered phase to a spinel phase thus increasing the life of the battery. The phosphorus-containing additive also facilitates the formation of a cathode-electrolyte interphase (CEI) (also sometimes referred to as a solid electrolyte interphase (SEI) for the anode), which functions as an oxygen trap to reduce the battery volume expansion. The phosphorus-containing additive facilitates an enhanced stability which increases the decomposition temperature of electrolyte. This improves battery life.

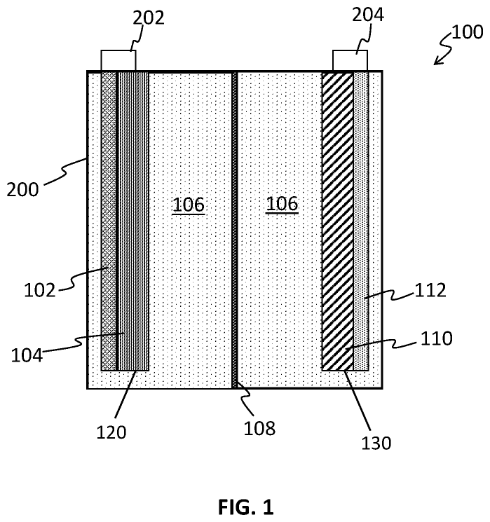

FIG. 1 depicts a cross-section of an exemplary lithium ion battery 100 that comprises an anode 120 and a cathode 120 contained in a housing 200 that also contains a separator 108 and an electrolyte 106. The anode includes an anode current collector 102 with an anode active material layer 104 disposed on thereon and the cathode includes a cathode active material layer 110 which is disposed on a cathode current collector 112. The various components of the battery 100 are contained in a housing 200 that contains terminals 202 and 204 which are typically in electrical communication with a load (not shown).

The anode active material layer 104 and the cathode active material layer 110 are generally manufactured by disposing an anode active material layer and a cathode active material layer on the anode current collector 102 and the cathode current collector 112 respectively. The liquid electrolyte 106 surrounds the anode 120 and the cathode 130. The separator 108 generally comprises an electrically insulating material and is disposed between the anode 120 and the cathode 130.

The anode current collector 102 and the cathode current collector 112 generally comprise metals. In an embodiment, the anode current collector comprises stainless steel, copper, nickel, iron, titanium, or a combination thereof, while the cathode current collector comprises stainless steel, aluminum, nickel, iron, titanium, or a combination thereof.

The electrolyte 106 will first be described followed by the electrode (the anode and cathode) active material layers, the materials used in the respective active material layers, the method of manufacture the respective electrodes and the method of manufacturing the battery 100.

The electrolyte 106 used in the lithium ion battery comprises a lithium salt, the phosphorus-containing additive and a solvent. It is desirable for the lithium salt to completely dissolve and dissociate in the electrolyte and the solvated lithium ions (Li⁺) should have high mobility for ion transportation. The anion should be stable against oxidative decomposition at the cathode and reductive decomposition at the anode. Examples of lithium salts include lithium hexafluorophosphate (LiPF₆), lithium perchlorate (LiClO₄), lithium hexafluoroarsenate (LiAsF₆), lithium tetrafluoroborate (LiBF₄), lithium bis(trifluoro-methanesulfonyl)imide (LiTFSI), lithium bis(fluorosulfonyl)imide (LiFSI), lithium bis(oxalato)borate (LiBOB), lithium (difluoromethanesulfonyl) (trifluoromethanesulfonyl)imide (LiDFTFSI), lithium difluorooxalatoborate (LIODFB), lithium difluorophosphate (LiPO₂F₂), lithium iodide (LiI), lithium bromide (LiBr), lithium chloride (LiCl), lithium thiocyanate (LiSCN), lithium nitrate (LiNO₃), lithium nitrite (LiNO₂), lithium sulfate (Li₂SO₄), or a combination thereof.

The lithium salts are present in the electrolyte in an amount of 5 to 30 weight percent (wt %), based on a total weight of the electrolyte.

The electrolyte 106 also contains a phosphorus-containing additive that reduces electrolyte decomposition and the oxygen generation that results from the decomposition. In an embodiment, the phosphorus-containing additive can include at least one of fluorine, silicon, or a combination thereof. The fluorine or silicon is present in the phosphorus-containing additive may be covalently or ionically bonded directly or indirectly to the phosphorus atom. The phosphorus-containing additive acts as an oxygen trap to reduce cell volume expansion.

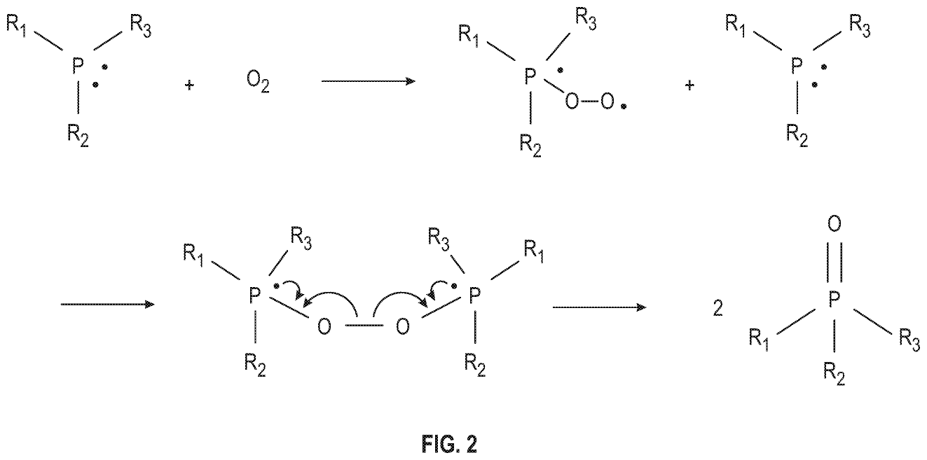

A mechanism of one exemplary interaction of the phosphorus-containing additive with oxygen which facilitates the removal of oxygen gas generated in the battery is depicted in the FIG. 2. FIG. 2 depicts an exemplary reaction of a phosphite molecule (e.g., a hydrogen phosphonate or an acid phosphite) with oxygen to form a phosphate. The reaction with the oxygen molecule to form a phosphate facilitates the removal of oxygen produced in the battery, thus preventing expansion of the cell and geometrical distortion.

Examples of the phosphorus-containing additives that may be used in the electrolyte include phosphites, phosphinates, phosphonates, phosphates, or a combination thereof. In an embodiment, the phosphorus-containing additive includes organophosphites, organophosphates, organophosphonites, organophosphonates, or a combination thereof.

Examples of organophosphites and organophosphinites include trimethyl phosphite (TMPi), triethyl phosphite, triisopropyl phosphite, ethyl diphenylphosphinite, triphenyl phosphite (TEPi), tris(2,2,2-trifluoroethyl) phosphite, tris(1,1,1,3,3,3-hexafluoropropan-2-yl) phosphite, tris(trimethylsilyl) phosphite, or the like, or a combination thereof.

Examples of suitable organophosphates include trimethyl phosphate (TMPa), triphenyl phosphate, tributyl phosphate, triethyl phosphate, tris(2,2,2,-trifluoroethyl) phosphate, bis(2,2,2-trifluoroethyl) methyl phosphate, tris(1,1,1,3,3,3-hexafluoropropan-2-yl) phosphate, or the like, or a combination thereof.

Examples of suitable organophosphonates include dimethyl methylphosphonate, diethyl ethylphosphonate, diethyl phenylphosphonate, bis(2,2,2-trifluoroethyl)methylphosphonate, bis(2,2,2,-trifluoroethyl)methyl phosphonate, or the like, or a combination thereof.

Combinations of any one of the foregoing phosphorus-containing additives may be used. For example, the phosphorus-containing additive may include an organophosphate as well as an organophosphite. A preferred phosphorus-containing additive is tris(2,2,2-trifluoroethyl) phosphite.

The phosphorus-containing additive may be present be present in the electrolyte in an amount of 0.001 to 20 wt %, preferably 0.01 to 10 wt %, and more preferably 0.1 to 5 wt %, based on a total weight of the electrolyte.

The electrolyte 106 contains a solvent that solvates the lithium salts as well as the phosphorus-containing additive. The solvent should facilitate ion mobility. Examples of suitable solvents include diethyl carbonate (DEC), fluoroethylene carbonate (FEC), difluoroethylene carbonate (DFEC), 1,2-dimethoxyethane (DME), trifluoroethylene carbonate (TFEC), vinyl ethylene carbonate (VEC), 4-methylene ethylene carbonate (MEC), ethylene carbonate (EC), propylene carbonate (PC), vinylene carbonate (VC), 4,5-dimethylene-1,3-dioxolan-2-one, dimethyl carbonate (DMC), ethyl methyl carbonate (EMC), methyl 2,2,2-trifluoroethyl carbonate (MFEC), dimethyl sulfone (DMS), ethyl methyl sulfone (EMS), ethyl vinyl sulfone (EVS), tetramethylene sulfone (TMS), trifluoromethyl ethyl sulfone (FMES), trifluoromethyl isopropyl sulfone (FMIS), trifluoropropyl methyl sulfone (FPMS), ethylene sulfite, ethylene sulfate, dimethyl sulfoxide (DMSO), acetonitrile, N,N-dimethylformamide (DMF), water, or the like, or a combination thereof.

Cosolvents may also be used. In an embodiment, water may be used to solvate the lithium salt, prior to mixing with one or more solvents. When cosolvents are used, the first solvent may be used in an amount of 10 to 90 volume percent (vol %), preferably 20 to 80 vol %, based on a total volume of the solvent used in the electrolyte. The second solvent may also be used in an amount of 10 to 90 vol %, preferably 20 to 80 vol %, based on a total volume of the solvent used in the electrolyte.

A suitable cosolvent system includes diethyl carbonate and fluoroethylene carbonate. When diethyl carbonate and fluoroethylene carbonate are used in a cosolvent system, the diethyl carbonate may be used in an amount of 10 to 90 vol %, preferably 15 to 85 vol %, preferably 75 to 85 vol %, based on a total weight of the solvent used in the electrolyte. The fluoroethylene carbonate may also be used in an amount of 10 to 90 vol %, preferably 15 to 85 vol %, preferably 15 to 25 vol %, based on a total weight of the solvent used in the electrolyte.

The electrolyte 106 is prepared by mixing the lithium salt, the phosphorus-containing additive and the solvent in the appropriate amounts to form a solution. The mixing is conducted in a blender where shear is applied to the ingredients. Suitable mixers include Waring blenders, Henschel mixers, planetary mixers and single or twin screw extruders. The mixing may be conducted at ambient temperatures and pressures or at an elevated temperature and pressure if desired. In a preferred embodiment, the mixing is conducted at ambient temperature and pressure. The electrolyte 106 is disposed in the battery housing 200 when desired.

The manufacturing of the electrodes (the anode 120 or the cathode 130) will now be described. In an embodiment, a slurry that is used to form the electrodes comprises a solvent, an electrically conducting additive, a polymeric binder, an active material (the active material can be an anode active material or a cathode active material depending upon which particular electrode (anode or cathode) it is used in.

The solvents used in the manufacturing of the anode active layer 104 and the cathode active layer 110 may be the same as those listed above and will not be detailed again in the interests of brevity.

The electrically conducting additive preferably comprises an electrically conducting carbonaceous material. Examples of electrically conducting carbonaceous materials include carbon nanotubes, carbon black, activated carbon, graphene, graphite, graphite oxide, carbon fibers, or the like, or a combination thereof. It is desirable for the electrically conducting composition to form an electrically conducting network that extends from a surface of the current collector to the surface of the electrode (that contacts the electrolyte).

Carbon nanotubes include single wall carbon nanotubes (SWNTs), double wall carbon nanotubes (DWNTs), multiwall carbon nanotubes (MWNTs), or a combination thereof and have diameters of 2 to 100 nanometers, preferably 10 to 50 nanometers. They have lengths of 20 to 10,000 nanometers, preferably 200 to 5000 nanometers. Aspect ratios greater than 10, preferably greater than 50 and more preferably greater than 100 are desirable.

Carbon black having a high surface area is preferred for use in the electrode. Carbon black (subtypes are acetylene black, channel black, furnace black, lamp black and thermal black) is a material produced by the incomplete combustion of coal and coal tar, vegetable matter, or petroleum products, including fuel oil, fluid catalytic cracking tar, and ethylene cracking in a limited supply of air. Carbon black is a form of paracrystalline carbon that has a high surface-area-to-volume ratio, albeit lower than that of activated carbon. Carbon black having a surface area of 50 to 1000 m²/gm may be used in the slurry that is used to form the electrode.

Activated carbon also called activated charcoal, is a form of carbon that has a surface area in excess of 3,000 m²/gm as determined by gas adsorption. It can be used in conjunction with other electrically conducting carbonaceous elements listed herewith. Examples of carbon black or activated carbon that can be used in the electrode-forming slurry are KELTJEN™ Black or Super P.

Graphene is an allotrope of carbon consisting of a single layer of atoms arranged in a hexagonal lattice nanostructure. Graphene that is added to the slurry may be in the form of individual graphene sheets or in the form of a plurality of loosely connected graphene sheets. Each atom in a graphene sheet is connected to its three nearest neighbors by σ-bonds and a delocalized x-bond, which contributes to a valence band that extends over the whole sheet. This is the same type of bonding seen in carbon nanotubes and polycyclic aromatic hydrocarbons, and in fullerenes and glassy carbon. The valence band is touched by a conduction band, making graphene a semimetal with unusual electronic properties that are best described by theories for massless relativistic particles.

In an embodiment, the graphene can be in the form of graphene nanoplatelets (GNP). Exfoliated graphite nano-platelets comprise nanoparticles that contain graphite These nanoparticles consist of small stacks of graphene that are 1 to 15 nanometers thick, with diameters ranging from sub-micrometer to 100 micrometers.

Graphite particles may also be used in the electrically conducting composition. Graphite is a natural manifestation of pure carbon with a hexagonal crystal structure that is arranged in several parallel levels, called graphene layers. In short, graphite particles comprise a plurality of graphene sheets that are arranged to be parallel to each other. This anisotropic structure gives the graphite special properties, such as electrical conductivity or a particular strength along the individual layers. It is extremely heat-resistant with a sublimation point of over 3,800° C., thermally highly conductive and chemically inert.

Graphite oxide (GO), sometimes called graphene oxide, graphitic oxide or graphitic acid, is a compound of carbon, oxygen, and hydrogen in variable ratios, obtained by treating graphite with strong oxidizers and acids for resolving of extra metals. The maximally oxidized bulk product is a yellow solid with a C:O ratio between 2.1:1 and 2.9:1, that retains the layer structure of graphite but with a much larger and irregular spacing. The bulk material spontaneously disperses in basic solutions or can be dispersed by sonication in polar solvents to yield monomolecular sheets, known as graphene oxide by analogy to graphene, the single-layer form of graphite. Graphene oxide sheets exist in the form of strong paper-like materials, membranes, thin films, and composite materials and can be used in the electrode-forming slurry that is used to prepare the electrodes.

Carbon fibers have diameters of 5 to 10 micrometers and are composed mostly of carbon atoms. They can have lengths greater than 1000 micrometers, preferably greater than 10,000 micrometers. The are produced by drawing pitch or polyacrylonitrile polymeric fibers under high pressures and temperatures of over 1500° C., preferably at temperatures greater than 2200° C. Carbon fibers are different from carbon nanotubes and do not have cylindrical graphene sheets arranged concentrically. The carbon fibers typically comprise high aspect ratio graphene sheets arranged to be in a parallel configuration with each other.

The aforementioned carbon nanotubes, carbon black, activated carbon, graphene sheets, graphite particles, graphite oxide particles, or a combination thereof may be used individually or in any combination to form an electrically conducting network. In an exemplary embodiment, the carbon nanotubes typically are used in the largest amount when compared with the other carbonaceous ingredients.

The active layer may contain the electrically conducting additive in an amount of up to 5 wt %, preferably 1 to 4 wt %, based on a total weight of the active layer.

The electrode-forming slurry also optionally comprises a polymeric binder. The polymeric binder binds the electrically conducting additive and the active material so that they remain in contact with the current collector and do not get dispersed in the electrolyte during the manufacturing process or during use. The polymeric binder preferably does not reduce electrical conductivity of the active layer disposed on the current collector. The active layer comprises the electrically conducting additive and the respective anode or cathode active material.

The polymeric binder is preferably a fluorine containing homopolymer or copolymer. In a preferred embodiment, the binder is a fluorine containing copolymer. In an embodiment, the fluorine containing copolymer is at least one of poly (vinylidene fluoride-co-chlorotrifluoroethylene) (abbreviated as P(VDF-CTFE)), poly(vinylidene fluoride-trifluoroethylene) (abbreviated as P(VDF-TeFE)), poly(vinylidene fluoride-trifluoroethylene-chlorofluoroethylene) terpolymer (abbreviated as P(VDF-TrFE-CFE)), poly(vinylidene fluoride-hexafluoropropylene) (abbreviated as P(VDF-HFP) or PVDF-HFP), or a combination thereof. In a preferred embodiment, the polymeric binder used in the active layer is poly(vinylidene fluoride-hexafluoropropylene) copolymer. The polymeric binder has a weight average molecular weight of 5,000 to 1,000,000 grams per mole, preferably 50,000 to 750,000 grams per mole, and more preferably 75,000 to 500,000 grams per mole measured using gel permeation chromatography with a polystyrene standard.

In an embodiment, the polyvinylidene content of any of the aforementioned binders is 80 to 95 wt %, based on a total weight of the polymeric binder. The remaining polymer content of the copolymer is 5 to 20 wt %, based on the total weight of the polymeric binder. For example, if the polymeric binder is a poly(vinylidene fluoride-hexafluoropropylene) copolymer, then the polyvinylidene content of the copolymer is 80 to 95 wt %, based on a total weight of the polymeric binder, while the poly hexafluoropropylene content of the copolymer is 5 to 20 wt %, based on a total weight of the copolymer.

The total weight of the polymeric binder in the active layer after the solvent is removed is less than 10 wt %, preferably less than 8 wt %, and more preferably less than 5 wt %, and more preferably less than 3 wt % of a total weight of the active layer. The polymeric binder if present, is present in an amount of greater than 0.1 wt % of the total weight of the active layer. A lower weight of the polymeric binder in the active layer facilitates a lower reduction in the electrically conducting capabilities of the active layer. In other words, the lower the amount of the polymeric binder, the greater the electrical conducting capacity of the active layer will be. The active layer is disposed on the current collector and comprises the pertinent (anode or cathode) active material, the electrically conducting additive and the polymeric binder.

The electrode-forming slurry contains an active material. The active material may be different depending upon whether the slurry is used to form the anode active layer or the cathode active layer.

Anode active materials include some of the aforementioned carbonaceous materials, hard carbon, silicon, silicon mixed with graphite, silicon oxide mixed with graphite, carbon encapsulated silicon particles, Li₄Ti₅O₁₂; transition metals such as, for example, tin, metal oxides, metal sulfides, (e.g., TiO₂, FeS, and the like) lithium metal and alloys, or a combination thereof. Exemplary active materials may include graphite, hard carbon, activated carbon, nanoform carbon, silicon, silicon oxides, silicon oxide mixed with graphite, carbon encapsulated silicon nanoparticles, or a combination thereof. In some such embodiments, the anode active material may be intercalated with lithium (e.g., using pre-lithiation methods known in the art).

Hard carbon is a solid form of carbon that cannot be converted to graphite by heat-treatment, even at temperatures as high as 3000° C. It is also known as char, or non-graphitizing carbon. Hard carbon is produced by heating carbonaceous precursors to approximately 1000° C. in the absence of oxygen. Among the precursors for hard carbon are polyvinylidene chloride (PVDC), lignin and sucrose. Other precursors, such as polyvinyl chloride (PVC) and petroleum coke, produce soft carbon, or graphitizing carbon. Soft carbon can be readily converted to graphite by heating to 3000° C.

In a preferred embodiment, the anode active material comprises silicon oxide mixed with graphite. The anode active material may be used in the anode active layer respectively in an amount of 3 to 99 wt %, preferably 4 to 60 wt %, based on a total weight of the anode active layer.

Lithium (Li)- and manganese-rich (LMR) layered-structure materials may be used as cathode active materials. Lithium-manganese-rich (LMR) layered oxides, also known as over-lithiated oxides (OLO), are of interest as cathode materials for lithium-ion batteries given their high capacities (greater than 250 mAh/g) and energy densities. An example of an LMR is provided in Equation (1) below:

$$( p ) {Li}_{2} {MnO}_{3} ( 1 - p ) {Li R}_{1} {O}_{2} , \qquad ( 1 )$$

where R₁ is Mn, Ni or Co and p is greater than zero and less than 1.

Another example of an LMR is provided in Equation (2) below:

$${Li R}_{x} {M}_{y} {O}_{2} , \qquad ( 2 )$$

where R is Ni and M is at least one of Mn, Ni, Co, or Al, where x+y<1 and where x is greater than 0.1 and less than 0.5.

An example of a LMR is Li [Li_{1/3}Mn_{2/3}]O₂ (generally designated as Li₂MnO₃) and LiR₁O₂ (where R₁ is nickel) with a specific capacity of approximately 250 mAh/g. Other LMR's that may be used in the cathode active layer include lithium manganese oxide (LMO with variant formulas of LiMn₂O₄, Li₂MnO₃ and others), LiNbO₃-coated LiMn₂O₄ and Al-doped LiMn₂O₄,

Examples of other LMR's include lithium cobalt oxide (LCO, sometimes called “lithium cobaltate” or “lithium cobaltite”-one variant of which is LiCoO₂); lithium nickel manganese cobalt oxide (NMC, with a variant formula of LiNiMnCo); lithium nickel cobalt aluminum oxide (LiNiCoAlO₂ and variants thereof as NCA) and lithium titanate oxide (LTO, with one variant formula being Li₄Ti₅O₁₂); lithium iron phosphate oxide (LFP, with one variant formula being LiFePO₄), lithium nickel cobalt aluminum oxide (and variants thereof as NCA) as well as other similar other materials, spinel (LiMn₂O₄, LiNi_{0.5}Mn_{1.5}O₄), polyanion cathode (LiV₂(PO₄)₃), and other lithium transition-metal oxides. Low voltage cathode materials (e.g., lithiated metal oxide/sulfide (e.g., LiTiS₂), lithium sulfide and sulfur) may also be used.

Other variants of the foregoing may be included. In some embodiments where NMC is used as an active material, nickel rich NMC may be used. For example, in some embodiments, the variant of NMC may be LiNiₓMn_{y}Co_{(1-x-y)}O₂, LiNiₓMn_{y}Al_{(1-x-y)}O₂, LiNiₓMn₍₁₋ₓ₎O₂, Li₁₊ₓMO₂, or a combination thereof, where x is equal to or greater than about 0.7, 0.75, 0.80, 0.85, or more and where y is less than 0.15, preferably less than 0.1. In some embodiments, NMC811 may be used, where in the foregoing formula x is about 0.8 and y is about 0.1.

In yet another embodiment, the lithium and manganese-rich layered-structure material is Li_{z}NiₓMn_{y}Co_{(1-x-y)}O₂, LiNiₓMn_{y}Al_{(1-x-y)}O₂, LiNiₓMn₍₁₋ₓ₎O₂, or a combination thereof, where y is equal to or greater than about 0.5 and where x is less than 0.4 and where z is equal to or greater than 1.0 and is less than 1.5.

The cathode active material may be used in the cathode active layer respectively in an amount of 70 to 99 wt %, preferably 95 to 98 wt %, based on a total weight of the cathode active layer.

The electrode-forming slurry can be manufactured in several different ways. In one embodiment, in one method of manufacturing the respective electrodes (the anode or the cathode), the electrically conducting composition, the polymeric binder, the anode or the cathode active materials and a solvent (such as those listed above) can be mixed in a single mixing device such as a blender for an appropriate amount of time to form the slurry. The time of mixing can be 30 minutes to 5 hours. The slurry with the appropriate active material is then disposed on the respective current collector to form the anode or cathode. The slurry after being disposed on the current collector is subjected to drying to form the active layer.

The drying may be conducted at a temperature of 50 to 80° C. for a period of 30 minutes to 10 hours, preferably 1 to 5 hours. The mixing is conducted in a planetary mixer, although other blenders such as Waring blenders, Henschel mixers, single and multiple screw extruders may also be used.

In an embodiment, the battery 100 is manufactured by disposing the anode 120 (which comprises the anode current collector 102 and the anode active layer 104 disposed thereon), the cathode 130 (which comprises the cathode current collector 112 and the cathode active layer 110 disposed thereon), the separator 108 and the electrolyte 106 (with the phosphorus-containing additive) in a housing 200. The housing 200 is the sealed. The battery is then provided with anode terminals 202 (which contact one or more anodes) and cathode terminals 204 (which contact one or more cathodes).

The N/P ratio of the lithium ion battery is the capacity ratio between the anode and cathode of the battery. The capacity ratio is typically an areal capacity. It is used to determine the battery performance and energy density. In an embodiment, the N/P ratio is controlled by adjusting the anode thickness with a fixed anode density. In another embodiment, the N/P ratio of the battery is 1 to 3, preferably 1.1 to 1.5, and more preferably 1.1 to 1.2. A N/P ratio greater than 1.10 can suppress lithium plating and enhance cycle performance. A N/P ratio between 1.15 and 1.40 can also show good discharge capacity.

A battery containing the aforementioned anode active layer, the cathode active layer and the electrolyte with the phosphorus-containing additive can operate in a voltage regime of 2.0 to 5.0 volts at a C-rate of C/100 to 6C. The C-rate is a measure of how fast a battery can be charged or discharged. It is defined as the current (in amps) divided by the capacity (in amp-hours). For example, if a battery has a capacity of 100 amp-hours and can be charged at a rate of 10 amps, the C-rate would be 10/100, or 0.1.

The battery with the aforementioned electrolyte is exemplified by the following non-limiting example.

### Example

This example was conducted to demonstrate the functioning of a lithium-ion battery that contains the phosphorus-containing additive as part of the electrolyte. The phosphorus-containing additive used in this example was tris(2,2,2-trifluoroethyl) phosphite (abbreviated as TTFPi).

Two lithium batteries were tested in this example—an experimental battery that contained the electrolyte with the phosphorus-containing additive and a comparative battery that contained the electrolyte with no phosphorus-containing additive included therewith. The components and the manufacturing of the respective cells are detailed below.

The electrolyte for both lithium-ion batteries comprises LiPF₆ as its lithium salt. A 1.2M solution of LiPF₆ is mixed with a co-solvent solution of fluoroethylene carbonate (FEC) and diethyl carbonate (DEC). The volume ratio of FEC to DEC is 1:4. The tris(2,2,2-trifluoroethyl) phosphite (TTFPi) was added to the electrolyte in the experimental battery only in an amount of 3 wt %, based on a total weight of the electrolyte. The comparative battery did not contain any tris(2,2,2-trifluoroethyl) phosphite (TTFPi) in its electrolyte and therefore contained only the 1.2M solution of LiPF₆ in the co-solvent solution of fluoroethylene carbonate (FEC) and diethyl carbonate (DEC) in a volume ratio of 1:4.

The anode active layer and the cathode active layer for both (the experimental and the comparative) lithium-ion batteries were identical and are detailed below.

The anode active layer comprises a mixture of silica and graphite (SiO/graphite) as the anode active material. The anode active material is present in the anode active layer in an amount of 5.5 wt %, based on a total weight of the anode active layer. The anode active layer used in this example contains 95 wt % of an active material that contained graphite and a combination of silica combined with graphite (SiO—C in an amount of 5.5 wt %), 3.9 wt % of a binder that contains carboxymethyl cellulose and styrene butadiene rubber in a 1:1 weight ratio and 1.1 wt % Super-P carbon black.

The cathode active layer comprises a layered lithium-magnesium-rich (LMR) layered cathode active material. The anode active layer contains 97 wt % of the LMR, 0.1 wt % of single wall carbon nanotubes, 1.05 wt % of Super-P carbon black, 0.6 wt % of graphene nanoplatelets (GNP) and 1.25 wt % of a polymeric binder that comprises polyvinylidene fluoride. All weight percents are based on a total weight of the cathode active layer.

The battery is cycled between 2 and 4.4V at C/3. The formation is conducted at 2.0 to 4.5 V at C/20. The C-rate (C) is defined as the charge/discharge current divided by the nominally rated battery capacity; here 1C=200 mA/g.

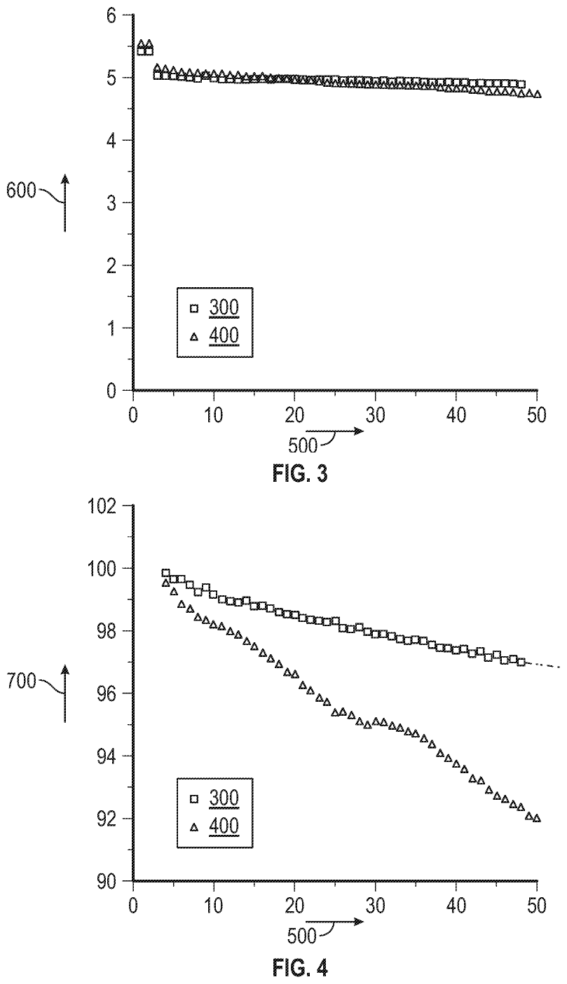

The performance of these two lithium batteries is compared in the graphs depicted in the FIGS. 3 and 4. FIG. 3 is a graph that depicts areal capacity (mAh/cm²) (600) versus the number of cycles (500) for the experimental battery (depicted by numeral 300) and for the comparative battery (depicted by numeral 400), while FIG. 4 is a graph that depicts percentage normalized capacity retention (700) versus the number of cycles (500) for the experimental battery (depicted by numeral 300) and for the comparative battery (depicted by numeral 400).

From the FIG. 3 it may be seen that the areal capacity of the experimental cell that contains the phosphorus-containing additive is greater than that of the comparative cells. This areal capacity increases with increasing number of cycles indicating that life-cycle of the cell can be improved by using an electrolyte that contains the phosphorus-containing additive. Similarly, from the FIG. 4 it may be seen that the normalized capacity retention is greater for the experimental cell than for the comparative cell with increasing number of cycles. Both of these examples demonstrate the utility of using a phosphorus-containing additive in an electrolyte. The phosphorus-containing additive facilitates a reduction in the rate of conversion of a layered phase in the lithium and manganese-rich layered-structure material to a spinel phase.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. An electrolyte for a lithium-ion battery comprising:
a lithium salt;
a phosphorus-containing additive; and
a solvent.

2. The electrolyte of claim 1, where the lithium salt is present in an amount of 5 to 30 wt %, based on a total weight of the electrolyte.

3. The electrolyte of claim 1, where the lithium salt is lithium hexafluorophosphate, lithium perchlorate, lithium hexafluoroarsenate, lithium tetrafluoroborate, lithium bis(trifluoro-methanesulfonyl)imide, lithium bis(fluorosulfonyl)imide, lithium bis(oxalato)borate, lithium(difluoromethanesulfonyl)(trifluoromethanesulfonyl)imide, lithium difluorooxalatoborate, lithium difluorophosphate, lithium iodide, lithium bromide, lithium chloride, lithium thiocyanate, lithium nitrate, lithium nitrite, lithium sulfate, or a combination thereof.

4. The electrolyte of claim 1, where the lithium salt is lithium hexafluorophosphate (LiPF₆).

5. The electrolyte of claim 1, where the phosphorus-containing additive is present in the electrolyte in an amount of 0.001 to 20 wt %, based on a total weight of the electrolyte.

6. The electrolyte of claim 3, where the phosphorus-containing additive is present in the electrolyte in an amount of 0.1 to 5 wt %, based on a total weight of the electrolyte.

7. The electrolyte of claim 1, where the phosphorus-containing additive is an organophosphite, an organophosphate, an organophosphonite, an organophosphonate, or a combination thereof.

8. The electrolyte of claim 7, where the organophosphite and organophosphinite is a trimethyl phosphite, a triethyl phosphite, a triisopropyl phosphite, a ethyl diphenylphosphinite, a triphenyl phosphite, a tris(2,2,2-trifluoroethyl) phosphite, a tris(1,1,1,3,3,3-hexafluoropropan-2-yl) phosphite, a tris(trimethylsilyl) phosphite, or a combination thereof.

9. The electrolyte of claim 7, where the organophosphate is a trimethyl phosphate, a triphenyl phosphate, a tributyl phosphate, a triethyl phosphate, a tris (2,2,2,-trifluoroethyl) phosphate, a bis(2,2,2-trifluoroethyl)methyl phosphate, tris(1,1,1,3,3,3-hexafluoropropan-2-yl) phosphate, or a combination thereof.

10. The electrolyte of claim 7, where the organophosphonate is a dimethyl methylphosphonate, a diethyl ethylphosphonate, a diethyl phenylphosphonate, a bis(2,2,2-trifluoroethyl)methylphosphonate, a bis(2,2,2,-trifluoroethyl)methyl phosphonate, or a combination thereof.

11. The electrolyte of claim 1, where the phosphorus-containing additive is a tris(2,2,2-trifluoroethyl) phosphite.

12. The electrolyte of claim 1, where the solvent is diethyl carbonate, fluoroethylene carbonate, difluoroethylene carbonate, 1,2-dimethoxyethane, trifluoroethylene carbonate, vinyl ethylene carbonate, 4-methylene ethylene carbonate, ethylene carbonate, propylene carbonate, vinylene carbonate, 4,5-dimethylene-1,3-dioxolan-2-one, dimethyl carbonate, ethyl methyl carbonate, methyl 2,2,2-trifluoroethyl carbonate, dimethyl sulfone, ethyl methyl sulfone, ethyl vinyl sulfone, tetramethylene sulfone, trifluoromethyl ethyl sulfone, trifluoromethyl isopropyl sulfone, trifluoropropyl methyl sulfone, ethylene sulfite, ethylene sulfate, dimethyl sulfoxide, acetonitrile, N,N-dimethylformamide, water, or a combination thereof.

13. The electrolyte of claim 1, where the solvent comprises diethyl carbonate and fluoroethylene carbonate.

14. The electrolyte of claim 13, where the diethyl carbonate is used in an amount of 75 to 85 vol %, based on a total weight of the solvent used in the electrolyte, and where the fluoroethylene carbonate is used in an amount of 15 to 25 vol %, based on a total volume of the solvent used in the electrolyte.

15. A lithium-ion battery comprising:
an anode that comprises an anode active layer;
a cathode that comprises a cathode active layer; where the cathode active layer comprises lithium and manganese-rich layered-structure material;
an electrolyte that comprising a phosphorus-containing additive; and
a separator disposed between the anode and the cathode.

16. The battery of claim 15, where the electrolyte further comprises a lithium salt; where the lithium salt is lithium hexafluorophosphate, lithium perchlorate, lithium hexafluoroarsenate, lithium tetrafluoroborate, lithium bis(trifluoro-methanesulfonyl)imide, lithium bis(fluorosulfonyl)imide, lithium bis(oxalato)borate, lithium(difluoromethanesulfonyl)(trifluoromethanesulfonyl)imide, lithium difluorooxalatoborate, lithium difluorophosphate, lithium iodide, lithium bromide, lithium chloride, lithium thiocyanate, lithium nitrate, lithium nitrite, lithium sulfate, or a combination thereof.

17. The battery of claim 15, where the lithium and manganese-rich layered-structure material has the formula of Equation (1) or Equation (2):
$$( p ) {Li}_{2} {MnO}_{3} ( 1 - p ) {Li R}_{1} {O}_{2} , \qquad ( 1 )$$
where R₁ is Mn, Ni or Co and p is greater than zero and less than 1;
$${Li R}_{x} {M}_{y} {O}_{2} , \qquad ( 2 )$$
where R is Ni and M is at least one of Mn, Ni, Co, or Al, where x+y=1 and where x is greater than 0.30 and less than 0.91.

18. The battery of claim 15, where the lithium and manganese-rich layered-structure material is Li_{z}NiₓMn_{y}Co_{(1-x-y)}O₂, LiNiₓMn_{y}Al_{(1-x-y)}O₂, LiNiₓMn₍₁₋ₓ₎O₂, or a combination thereof, or a combination thereof, where y is equal to or greater than about 0.5 and where x is less than 0.4 and where z is equal to or greater than 1.0 and is less than 1.5.

19. The battery of claim 15, where the phosphorus-containing additive reduces a rate of conversion of a layered phase in the lithium and manganese-rich layered-structure material to a spinel phase.

20. The battery of claim 15, where the phosphorus-containing additive is a tris(2,2,2-trifluoroethyl) phosphite.
